(19) United States
(12) Patent Application Publication
(10) Pub. No.: US 2023/0419700 A1
(43) Pub. Date: Dec. 28, 2023

(54) Method and device for identifying and extending the input context of a user, to make contextualized suggestions regardless of the software application used

(71) Applicant: ORANGE, Issy-les-Moulineaux (FR)

(72) Inventors: Tiphaine Marie, CHATILLON CEDEX (FR); Jean-François Letellier, CHATILLON CEDEX (FR); Frank Meyer, CHATILLON CEDEX (FR)

(21) Appl. No.: 18/342,021

(22) Filed: Jun. 27, 2023

(30) Foreign Application Priority Data
Jun. 28, 2022 (FR) 2206426

(51) Int. Cl. G06V 30/14; G06F 3/01

(52) U.S. Cl. CPC G06V 30/1456; G06F 3/013; G06V 2201/02

(57) ABSTRACT

A method for acquiring a textual context of a user. The method includes: obtaining at least one character originating from at least one input peripheral device of an electronic device; optical character recognition applied to all or part of an image representative of a content displayed by at least one display peripheral device of the electronic device to obtain a character sequence; searching for the at least one character in the character sequence and, when the search is positive, acquisition, from the character sequence, of the textual context.

### 1. FIELD OF THE DISCLOSURE

The present disclosure relates to the field of telecommunications and relates more particularly to a contextual aid service provided, for example, by a personal computer.

### 2. PRIOR ART

The contextual aid services proposed by a computer application (Word™, Writer™ Excel™, etc.) to its user rely on the analysis of the textual context of the user in the application. The textual context can for example comprise the text input/dictated by the user, the text formatting parameters, the movements and/or the position of the cursor, etc.

The contextual aid services correspond for example to:
assistance in correction (spelling, grammar, etc.), over the last sentence entered;
suggested automatic completion, based on the text and the latest words typed/input;
suggested information (for example from the Internet, from an intranet, from a local disk) in relation to the text on which the user is working;
suggested automatic actions (launching a complementary application, opening a specific file) in relation to the text/the document on which the user is working.

Each computer application which offers these contextual aid services uses only textual context data generated in the application. Furthermore, these computer applications do not share their textual context data with third-party applications. Furthermore, some computer applications do not offer such contextual aid services.

Thus, it has to be accepted that there is no solution that allows a third-party application to acquire the textual working context of an application currently being used by the user, and do so regardless of the application being used, in order to offer, transversely (independently of the application being used), contextual aid services.

### 3. SUMMARY

An aspect of the present disclosure relates to a method for acquiring a textual context of a user, characterized in that the method comprises:
a step of obtaining of at least one character originating from at least one input peripheral device of an electronic device;
a step of optical character recognition applied to all or part of an image representative of a content displayed by at least one display peripheral device of said electronic device to obtain a character sequence;
a step of searching for said at least one character in said character sequence and, when the search is positive
a step of acquisition, from said character sequence, of said textual context.

Advantageously, the acquisition method makes it possible to acquire the textual context of the user of an electronic terminal/device and do so regardless of the application/software being used by the latter. In concrete terms, the acquisition method obtains at least one character (for example the latest word or words input/entered/dictated by the user) from an input peripheral device (keyboard, mouse, microphone, etc.) of the electronic device. The acquisition method also obtains an image representative of the content displayed by a display peripheral device (screen, video projector, etc.) of the electronic device (screen capture). Once the image is obtained, an optical character recognition is applied to the latter and a retranscription of the text (character sequence or sequences) present in the image is obtained by the method. The method then searches for the latest word or words input by the user in the text obtained, that is to say in one or more character sequences. When the search is positive, the method then recovers, from the character sequence or sequences, the textual context of said user.

An input peripheral device is understood to be any device capable of interpreting an action of a user in the form of commands, of functions or of instructions making it possible to print, store or transmit characters (alphanumeric, punctuation, etc.). The input peripheral device is, for example, a keyboard, a screen and/or a touch surface, a mouse, a microphone (via speech recognition software), etc.

A display peripheral device is understood to be any device capable of graphically rendering a multimedia content (text, graphical interface, image, video, animation, clickable links, buttons, thumbnails, etc.).

An electronic device is understood to be any device capable at least of managing a display peripheral device and/or an input peripheral device (personal computer, smartphone, electronic tablet, television, onboard computer of a car, connected objects, etc.).

Textual context is understood to be the textual context of input of a user when the latter inputs, via software of “text editor” type, one or more characters. The textual context can correspond to one or more words input by the user or else to the words preceding and/or following the character or characters input by the user. The textual context can also comprise the text formatting parameters, the movements and/or the position of the cursor, etc.

According to a particular mode of implementation of the disclosure, a method as described hereinabove is characterized in that the acquisition step is followed by a step of suggestion of a multimedia content as a function of said textual context, said multimedia content being displayed by said display peripheral device in proximity to a point of interest positioned as a function of a position datum associated with at least one character of said at least one sequence corresponding to said at least one character obtained.

Advantageously, this embodiment makes it possible to suggest a multimedia content such as a video, an image or a text (for example in the form of a dedicated graphic window or pop-up) as a function of the textual context of the user. The multimedia content or contents suggested is or are displayed by the display peripheral device in proximity to a point of interest whose coordinates are the coordinates of the working position of the user.

In concrete terms, the working position of the user is determined using the optical character recognition. Indeed, the optical character recognition associates, with each character of the text generated, the position of the character in the image (of the screen capture).

Thus, when a match is found between the latest word or words input/dictated by the user and a subset of the text generated by the optical character recognition, the method can determine the position of the latest word or words input/dictated in the image by recovering the position of a character included in the subset (for example the position of the last character of the subset). Once the position/location of the working/input position of the user is determined, the method recovers the textual context of said user. The method then suggests multimedia contents as a function of the textual context recovered. The contents are displayed by the display peripheral device of the electronic device in proximity to a point of interest whose coordinates are the coordinates of the working position of the user.

Indeed, since the image obtained is faithful to the content displayed by the display peripheral device of the electronic device, the coordinates of a point of interest of the image correspond to the coordinates of the same point of interest displayed by the display peripheral device. The location can for example correspond to coordinates (in pixels, in centimetres, etc.) that can be interpreted by the display peripheral device of the electronic device.

Alternatively or in addition, the method can trigger the execution of software on the electronic device as a function of the textual context of the user. For example, when the user redirects an email and inputs a text which is interpreted as a meeting proposal, the method can then trigger the execution of a diary application so that the user can add the meeting to it and thus block the proposed timeslot.

According to a particular mode of implementation of the disclosure, a method as described above is characterized in that in said textual context comprises a subset of said sequence following and/or preceding said at least one character of said sequence corresponding to said at least one character obtained.

This embodiment makes it possible to take account of the word or words situated before and/or after the latest word or words input/dictated by the user. That corresponds for example to the insertion of words by the user in a pre-existing text. The fact that the word or words preceding and/or following the latest word or words input/dictated by the user are taken into account can make it possible to improve the relevance of a suggested textual context (completion, information, etc.).

According to a particular mode of implementation of the disclosure, a method as described above is characterized in that said optical character recognition is applied to a part of said image whose coordinates are determined as a function of at least one position datum associated with a part of said displayed content, watched by a user, said at least one second position datum being obtained after a step of assessment of a time during which an analysis of the ocular movements of said user captured by a camera of said electronic device indicates that the gaze of said user remains directed to said part of said displayed content. This embodiment makes it possible to limit the execution of the optical character recognition to a zone/part of the image representative of the content displayed by the display peripheral device of the electronic device. For this, the method analyses the ocular movements (eye-tracking) of the user captured by a camera of the electronic device. When the analysis indicates that the gaze of the user remains directed for a predefined time to a zone/part of the content displayed by the display device, the method recovers the position (coordinates) of the content being watched by the user then defines a working zone (for example a square of 200 pixel size with the recovered coordinates at the centre thereof). The method then performs the optical character recognition over a zone of the image corresponding to the working zone defined (that is to say having the same coordinates). This embodiment makes it possible to optimize the use of the computer resources used (memory, processor, etc.).

According to a particular mode of implementation of the disclosure, a method as described above is characterized in that said optical character recognition is applied to a part of said image whose coordinates correspond to those of an active graphic window displayed by said display device.

This embodiment makes it possible to limit the execution of the optical character recognition to a zone/part of the image representative of the content displayed by the display peripheral device of the electronic device corresponding to the active graphic window displayed by the display peripheral device of the electronic device. This embodiment makes it possible to optimize the use of the resources (memory, processor, etc.) that are necessary to the execution of the method.

An active graphic window is understood to be a graphic window displayed by a computer software during use by a user (for example a graphic window which has the “focus”).

According to a particular mode of implementation of the disclosure, a method as described above is characterized in that it is executed at regular intervals.

This embodiment makes it possible to acquire the textual context of the user over time. That for example makes it possible for the method to adapt, in real time, the multimedia content suggestions issued to the user.

According to a particular mode of implementation of the disclosure, a method as described above is characterized in that the execution of the method is stopped as a function of the value of a subset of said sequence preceding said at least one character of said sequence corresponding to said at least one character obtained.

This embodiment makes it possible to stop the execution of the method and therefore the acquisition of the textual context of the user when the latter detects one or more special characters (for example asterisks or periods), a word or a predefined set of words in the text generated by an optical character recognition method or software. The word or words can correspond to the terms “password”, “secret code”, or any other textual element indicating a confidential zone and/or text. This embodiment makes it possible to guarantee the confidentiality of certain data.

According to a particular mode of implementation of the disclosure, a method as described above is characterized in that the stopping of the execution of the method is followed by a step of issuing of a notification.

This embodiment makes it possible to issue a notification to third-party software asking for the “listening” to the events originating from the input peripheral devices to be stopped. This notification can for example be broadcast via the operating system of the electronic device. This embodiment also makes it possible to issue a notification, to the user, indicating to him or her that the method is stopped. This notification can for example be made via a specific sound, the blinking of a light-emitting diode or else the display of a text on the display peripheral device of the electronic device.

According to a particular mode of implementation of the disclosure, a method as described above is characterized in that the execution of the method is stopped as a function of the value of said at least one character obtained.

This embodiment makes it possible to stop the execution of the method when the latter detects that the latest word or words input/dictated by the user resemble a conventional password. For example, a word of six or more characters, not present in a dictionary and including special characters.

An aspect of the present disclosure relates also to a device for acquiring a textual context of a user, characterized in that the device comprises:
an obtaining module capable of obtaining at least one character originating from at least one input peripheral device of an electronic device;
an optical character recognition module capable of performing an optical character recognition over all or part of an image representative of a content displayed by at least one display peripheral device of said electronic device and making it possible to obtain a character sequence associated with said optical character recognition performed;
a module for searching for said at least one character in said character sequence;
a module for acquiring, from said character sequence, said textual context.

The term module can correspond equally to a software component and to a hardware component or a set of hardware and software components, a software component itself corresponding to one or more computer programs or subprograms or, more generally, to any element of a program capable of implementing a function or a set of functions as described for the modules concerned. Likewise, a hardware component corresponds to any element of a hardware set capable of implementing a function or a set of functions for the module concerned (integrated circuit, chipcard, memory card, etc.).

An aspect of the present disclosure relates also to a computer program comprising instructions for the implementation of the above method according to any one of the particular embodiments described previously, when said program is run by a processor. The method can be implemented in various ways, notably in hard-wired form or in software form. This program can use any programming language, and be in the form of source code, object code, an intermediate code between source code and object code, such as in a partially compiled form, or in any other desirable form.

An aspect of the present disclosure also targets a system for acquiring a textual context of a user, characterized in that the system comprises:
an electronic device for obtaining at least one character from at least one input peripheral device connected to said electronic device and display a content including said at least one character via at least one display peripheral device connected to said electronic device;
an optical character recognition device for performing an optical character recognition on all or part of an image representative of said content displayed by said at least one display peripheral device of said electronic device and making it possible to obtain a character sequence associated with said optical character recognition performed;
a device for searching for said at least one character in said character sequence;
a device for acquiring, from said character sequence, said textual context.

An aspect of the present disclosure also targets a computer-readable storage medium or information medium, comprising instructions of a computer program as mentioned above. The storage media mentioned above can be any entity or device capable of storing the program. For example, the medium can comprise a storage means, such as a ROM, for example a CD ROM or a microelectronic circuit ROM, or even a magnetic storage means, for example a hard disk. Also, the storage media can correspond to a transmissible medium such as an electrical or optical signal, which can be conveyed via an electrical or optical cable, wirelessly or by other means. The programs according to one or more aspects of the disclosure can in particular be downloaded over a network of Internet type.

Alternatively, the storage media can correspond to an integrated circuit in which the program is incorporated, the circuit being adapted to execute or to be used in the execution of the method concerned.

This acquisition device, this acquisition system and this computer program offer features and advantages similar to those described previously in relation to the acquisition method.

### 4. LIST OF THE FIGURES

Other features and advantages of the disclosure will become more clearly apparent on reading the following description of particular embodiments, given as simple illustrative and nonlimiting examples, and the attached drawings, in which:

FIG. 1 illustrates an example of environment of implementation according to a particular embodiment of the disclosure,

FIG. 2 illustrates the architecture of a device suitable for implementing the acquisition method, according to a particular embodiment of the disclosure,

FIG. 3 illustrates the main steps of the acquisition method according to a particular embodiment of the disclosure.

### 5. DESCRIPTION OF ILLUSTRATIVE EMBODIMENTS OF THE DISCLOSURE

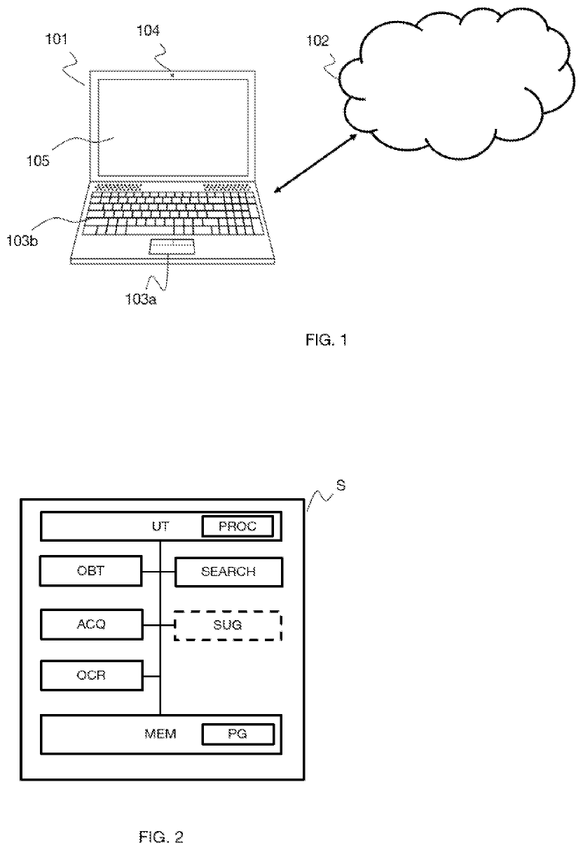

FIG. 1 illustrates an example of environment of implementation of the disclosure according to a particular embodiment. The environment represented in FIG. 1 comprises at least one terminal 101 that includes a device for acquiring a textual context capable of implementing the method for acquiring a textual context according to the present disclosure. The method can operate permanently and autonomously upon activation thereof or else following a user action.

According to other embodiments, the acquisition device can be situated in the network and/or distributed over one or more computing machines such as computers, terminals or servers.

The terminal 101 is for example a terminal of smartphone type, a tablet, a connected television, a connected object, an onboard computer of a car, a personal computer or any other terminal capable of rendering a multimedia content visually and/or vocally. One or more graphic/display (105) or sound rendering peripheral devices can be connected or else included by the terminal 101 (connected by wire (via a VGA, HDMI, USB, etc. cable) or else wirelessly (WiFi®, Bluetooth®, etc.). This or these rendering peripheral devices can for example be a screen, a video projector, a loudspeaker, etc.).

According to a particular embodiment of the disclosure, the graphic or sound rendering peripheral devices can be connected to the terminal 101 via the network 102.

Similarly, one or more input peripheral devices (103a, 103b) can be connected to or else included by the terminal 101 (connected by wire (via a VGA, HDMI, USB, etc. cable) or else wirelessly (WiFi®, Bluetooth®, etc.)). This or these input peripheral devices can for example be a keyboard, a mouse, a touch surface, a camera (104), a microphone or else any other peripheral device capable of supplying interaction data originating from the user of the terminal 101.

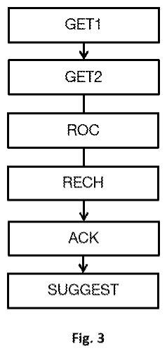

FIG. 2 illustrates a device (S) configured to implement the acquisition method according to a particular embodiment of the disclosure. The device (S) has the conventional architecture of a computer, and notably comprises a memory MEM, a processing unit UT, equipped for example with a processor PROC, and driven by the computer program PG stored in memory MEM. The computer program PG comprises instructions for implementing the steps of the acquisition method as described subsequently in support of FIG. 3, when the program is run by the processor PROC.

On initialization, the code instructions of the computer program PG are for example loaded into a memory before being executed by the processor PROC. The processor PROC of the processing unit UT notably implements the steps of the acquisition method according to any one of the particular embodiments described in relation to FIG. 3 and according to the instructions of the computer program PG.

The device (S) comprises an obtaining module OBT capable of obtaining at least one datum generated by a user (sound, movement, click, press (long or short), etc.) on an input peripheral device (103a (touchpad), 103b (keyboard)) of the terminal 101. These data are then interpreted and translated into characters. Such is for example the case when keys of the keyboard 103b of the terminal 101 are pressed, upon an action (movement, click) performed on a touch surface (103a), upon a retranscription of a speech in language of the signs picked up by the camera 104 of the terminal 101 or else upon a retranscription of an audio speech picked up by a microphone (not represented) of the terminal 101.

The device (S) also comprises an optical character recognition module (ROC) capable of performing an optical character recognition on an image (image capture) representative of the content displayed by a display peripheral device (105) of the terminal 101 and of obtaining a text (character sequence) as a result of the optical character recognition.

It should be noted that the image is for example generated via software capable of performing a capture of the graphic content of a screen (105) of the terminal 101.

The device (S) also comprises a search module (SEARCH) capable of searching, in the text obtained using the optical character recognition, for the character or characters (for example one or more words) obtained via the module OBT.

The device (S) also comprises an acquisition module ACQ capable of acquiring the textual context of the user as a function of the position of the word or words obtained via the module OBT in the text generated by the optical character recognition. The textual context can comprise the character or characters input by the user or else the word or words preceding and/or following the character or characters input by the user.

The device (S) can further comprise a module SUG capable of suggesting a multimedia content as a function of the textual context of the user obtained by the module ACQ.

FIG. 3 illustrates steps of the acquisition method according to a particular embodiment of the disclosure. In this example, the method is executed by the terminal 101 and a user drafts a text using a text editor run by the terminal 101.

In the first step (GET1) the method obtains a first datum originating from an input device/peripheral device. This datum corresponds to an interpretation of an action performed by a user of the terminal 101 on an input peripheral device. This action is, for example, a succession of presses detected on the keyboard (103b) of the terminal/computer 101. The datum, for its part, corresponds to an interpretation in the form of characters and/or character strings of the presses performed by the user. In this step, the method obtains a digit or a predefined number of characters originating from the input peripheral device, the character or characters obtained corresponding to the last character or characters typed/input by the user on the keyboard. In concrete terms, the character or characters just typed/input by the user are added/stored in a data structure of predetermined size such as a list of FIFO (first in first out) type. The added characters fill the list until the latter is full. Once the list is full, each added character replaces the oldest character contained in the list. This embodiment allows the method to have, at any instant in memory, the latest character or characters (for example the latest word or words) input/dictated by the user on the input peripheral device of the terminal 101.

According to a particular embodiment of the disclosure, when the user uses the “backspace”, “delete”, “right arrow” and “left arrow” keys of the keyboard, the list is modified so as to take account of these action commands/requests. For example, the sequence of keys: B O K “backspace” N J O P “left arrow” “delete” U R can be recomposed as “BONJOUR”.

In the second step (GET2) the method obtains an image representative of the content displayed by a display peripheral device (105) of the terminal 101. The image is, for example, obtained from software run by the terminal 101 capable of capturing the graphic content of the display peripheral device 105 of the terminal 101.

Alternatively, the image is obtained from a third-party terminal (for example a camera or a smartphone) positioned so as to capture the content displayed by a display peripheral device (105) of the terminal 101. The latter case may involve the transmission of the image by the third-party terminal to the terminal 101.

Alternatively, the method generates an image representative of the graphic content of the display peripheral device 105 of the terminal 101.

An optical character recognition (step ROC) is then applied to the image. The optical character recognition makes it possible to obtain a retranscription of the text contained in the image in the form of a character sequence/series, each character being associated with a position in the image/screen capture.

According to a particular embodiment of the disclosure, the optical character recognition is performed by third-party software and the result, that is to say the retranscription of the text (character series/sequence and the associated position thereof), is transmitted by the third-party software to the method.

According to a particular embodiment of the disclosure, the method performs the optical character recognition on the image.

Once the retranscription is obtained, the method searches (step RECH) for the character or characters obtained in the step GET1 in the character sequence. When the search is positive, the acquisition method recovers (ACK) the textual context of the user. The textual context can comprise:
the character or characters input by the user (obtained in the step GET1) and/or;
the word or words preceding the character or characters of the sequence/series corresponding to the characters input by the user, and/or;
the word or words following the character or characters of the sequence/series corresponding to the characters input by the user.

According to a particular embodiment of the disclosure, when the method detects several occurrences of the character string obtained in the step GET1 in the character sequence obtained via the optical character recognition, the method can increase the size of the list managed in the step GET1. Indeed, the higher the number of characters in the list (that is to say the larger the character string is), the lower the probability of having this character string several times in the character sequence.

According to a particular embodiment of the disclosure, the method proposes (step SUGGEST) one or more multimedia contents (image, text, video, etc.) to the user of the terminal 101 as a function of the textual context of the user recovered in the step ACK. The suggested contents are for example displayed by the screen 105 of the terminal 101 in proximity to the position of a point of interest corresponding to the location, in the image, of the character or characters obtained in the step GET1. The position of the character or characters obtained in the step GET1 is determined by virtue of the positions (for example of the coordinates in pixels) associated with the characters of the sequence that correspond to the characters obtained in the step GET1. The positions of the characters of the sequence in the image and therefore in the content displayed by the display peripheral device 105 are determined via the optical character recognition. It should be noted that the display can be done via a dedicated graphic window (or pop-up).

According to a particular embodiment of the disclosure, the multimedia content or contents suggested can also be a function of a subset of characters of predefined size of the character sequence, the subset being able to be situated before and/or after the character or characters corresponding to the characters being sought (that is to say characters obtained in the step GET1). This embodiment makes it possible to take account of one or more words situated before and/or after a word/text inserted by the user in order to improve the relevance of the suggested textual contents.

According to a particular embodiment of the disclosure, the optical character recognition can be applied to a part/zone of the image determined as a function of an analysis of the ocular movements (eye-tracking) of the user captured by a camera 104 of the terminal 101. In concrete terms, when the method finds that the gaze of the user remains directed for a time period/predetermined time towards a zone/part of the screen 105, the latter recovers the position of the content watched by the user then defines a working zone (for example a square of 200 pixel size centred on the recovered coordinates). The method then performs the optical character recognition on a zone of the image corresponding to the working zone defined (that is to say having the same coordinates). This embodiment makes it possible to optimize the use of the computing resources (memory, processor, etc.) necessary to the execution of the optical character recognition.

According to a particular embodiment of the disclosure, the working zone is determined when the gaze of the user remains directed a plurality of times for a predetermined time period to a zone/part of the screen 105.

According to a particular embodiment of the disclosure, the optical character recognition can be applied to a part/zone of the image corresponding to an active graphic window displayed by computer software on the screen 105. To do this, the method obtains, for example via an image recognition or via the operating system of the terminal 101, the coordinates of the four corners of the active graphic window displayed on the screen 105. The method then performs the optical character recognition on the zone of the image corresponding to the zone of the graphic window, that is to say the zone that has the same coordinates. Similarly, this embodiment makes it possible to optimize the use of the resources (memory, processor, etc.) necessary to the execution of the optical character recognition.

According to a particular embodiment of the disclosure, the acquisition method is executed at regular intervals.

According to a particular embodiment of the disclosure, the execution of the acquisition method is stopped as a function of the result of a test of a subset of characters of predefined size of the character sequence, the subset being situated before the character or characters corresponding to the characters being sought (that is to say character or characters obtained in the step GET1).

This embodiment makes it possible to stop the execution of the method and therefore the acquisition of the textual context of the user when the latter detects one or more special characters (for example asterisks or periods) a word or a set of predefined words in a character series/sequence generated by the optical character recognition. The word or words can correspond to the terms “password”, “secret code”, or any other textual element indicating a confidential zone and/or text.

When the method stops, a notification can be issued to the user indicating to him or her that the method is being stopped or already stopped. This notification can for example be made via a specific sound, the blinking of a light-emitting diode or else the display of a text on the display peripheral device of the terminal 101.

Alternatively or in addition, a notification can be transmitted to third-party software asking for the “listening” to the events (that is to say the obtaining of characters) originating from the input peripheral devices to be stopped. This notification can for example be broadcast via the operating system of the electronic device.

According to a particular embodiment of the disclosure, the stop can be effective for a predetermined time period or else until the user relaunches (re-executes) the method.

According to a particular embodiment of the disclosure, the execution of the acquisition method is stopped as a function of the result of a test of the character string obtained in the step GET1. In concrete terms, the method tests the structure of the character string in order to determine if the latter includes special characters and comprises a number of characters greater than a predefined threshold. For example, when the character string input by the user corresponds to a word of six characters or more, that is not present in a dictionary and that includes special characters, there is a strong probability that the user has input an identifier or a password. In this case, the method does not propose textual contents. Thus, the obtaining of the characters input by the user via the input peripheral device is stopped and a sound and/or visual notification can be issued to the user to inform him or her thereof. The stop is for example effective for a predetermined time period or else until the user relaunches the method. Alternatively or in addition, a notification can be issued to third-party software asking for the “listening” to the events (that is to say the obtaining of characters) originating from the input peripheral devices to be stopped. This notification can for example be broadcast via the operating system of the electronic device.

Although the present disclosure has been described with reference to one or more examples, workers skilled in the art will recognize that changes may be made in form and detail without departing from the scope of the disclosure and/or the appended claims.

What is claimed is:

1. A method for acquiring a textual context of a user, wherein the method comprises:
obtaining at least one character originating from at least one input peripheral device of an electronic device;
optical character recognition applied to all or part of an image representative of a content displayed by at least one display peripheral device of said electronic device to obtain a character sequence;
searching for said at least one in said character sequence
and, in response to the search being positive,
acquiring, from said character sequence, said textual context.

2. The method according to claim 1, wherein the acquiring is followed by suggesting a multimedia content as a function of said textual context, said multimedia content being displayed by said display peripheral device in proximity to a point of interest positioned as a function of a position datum associated with at least one character of said character sequence corresponding to said at least one character obtained.

3. The method according to claim 1, wherein said textual context comprises a subset of said sequence subsequent and/or preceding said at least one character of said sequence corresponding to said at least one character obtained.

4. The method according to claim 1, wherein said optical character recognition is applied to a part of said image whose coordinates are determined as a function of at least one position datum associated with a part of said displayed content, watched by a user, said at least one second position datum being obtained after assessing a time during which an analysis of ocular movements of said user captured by a camera of said electronic device indicates that a gaze of said user remains directed to said part of said displayed content.

5. The method according to claim 1, wherein said optical character recognition is applied to a part of said image whose coordinates correspond to those of an active graphic window displayed by said display device.

6. The method according to claim 1, wherein execution of the method is stopped as a function of a value of a subset of said sequence preceding said at least one character of said sequence corresponding to said at least one character obtained.

7. The method according to claim 7, wherein the stopping of the execution of the method is followed by issuing a notification.

8. The method according to claim 1, wherein execution of the method is stopped as a function of a value of said at least one character obtained.

9. A device for acquiring a textual context of a user, wherein the device comprises:
at least one processor; and
at least one non-transitory computer readable medium comprising instructions stored thereon which when executed by the at least one processor configure the device to acquire the textual context by:
obtaining at least one character originating from at least one input peripheral device of an electronic device;
performing an optical character recognition over all or part of an image representative of a content displayed by at least one display peripheral device of said electronic device and making it possible to obtain a character sequence associated with said optical character recognition performed;
searching for said at least one character in said character sequence;
acquiring, from said character sequence, said textual context.

10. A system for acquiring a textual context of a user, wherein the system comprises:
at least one input peripheral device to obtain at least one character;
at least one display peripheral device connected to the at least one input peripheral device to display a content comprising said at least one character;
at least one processor; and
at least one non-transitory computer readable medium comprising instructions stored thereon which when executed by the at least one processor implement a method of acquiring a textual context of a user by:
obtaining the at least one character originating from at least one input peripheral device;
performing an optical character recognition over all or part of an image representative of the content displayed by the at least one display peripheral device and making it possible to obtain a character sequence associated with said optical character recognition performed;
searching for said at least one character in said character sequence; and
acquiring, from said character sequence, said textual context.

11. A non-transitory computer readable medium comprising instructions for execution of an acquisition method, when the program is run by a processor, wherein the acquisition method comprises:
obtaining at least one character originating from at least one input peripheral device of an electronic device;
optical character recognition applied to all or part of an image representative of a content displayed by at least one display peripheral device of said electronic device to obtain a character sequence;
searching for said at least one in said character sequence
and, in response to the search being positive,
acquiring, from said character sequence, a textual context of a user.
